(19) United States
(12) Patent Application Publication
(10) Pub. No.: US 2008/0097805 A1
(43) Pub. Date: Apr. 24, 2008

(54) Transaction processing method

(76) Inventor: R. Scott Wells, Inkom, ID (US)

Correspondence Address: LITMAN LAW OFFICES, LTD., P.O. BOX 15035, CRYSTAL CITY STATION, ARLINGTON, VA, 22215, US

(21) Appl. No.: 11/882,894

(22) Filed: Aug. 6, 2007

Related U.S. Application Data
(60) Provisional application No. 60/853,458, filed on Oct. 23, 2006.

(51) Int. Cl. G06Q 10/00

(52) U.S. Cl. 705/7

(57) ABSTRACT

The transaction processing method is a computer-implemented method capable of logging events related to a consumer at a point of transaction. The event logging is performed at a transaction processing center. The transaction processing center can log such events as: receipts generated by a plurality of merchants doing business with the consumer; cash transactions generated at a plurality of cash transaction venues visited by the consumer; credit transactions generated by a plurality of creditors of the consumer; and non-financial events associated with the consumer. The events are reported to the transaction processing center by a plurality of associate members who contract with the center to provide the data. For each consumer, the event data can be stored in journal format on a server and made available for search, retrieval, display, and documentation by consumers who sign up to receive their journal information.

### CROSS-REFERENCE TO RELATED APPLICATION

This application claims the benefit of U.S. Provisional Patent Application Ser. No. 60/853,458, filed Oct. 23, 2006.

### BACKGROUND OF THE INVENTION

1. Field of the Invention

The present invention relates to systems and methods for electronic processing of transactions over a network, and more particularly to a transaction processing method that provides point of transaction (POT) processing, journaling, and access.

2. Description of the Related Art

To access bank accounts, credit card accounts, cash transactions, and investment accounts, typically, a user goes to each of these companies' Internet site to access the user's accounts. The user does not see all of his/her finances in one location and has to change back and forth between Internet sites. When accessing these different Internet sites it can be difficult and frustrating at times to remember all of the required user names and passwords that have been set up. It is also difficult to keep track of all of the cash transactions. Most people do not have the time to keep track of these transactions. Thus, the transactions do not get included into money management programs.

For example, every person that makes a purchase has a need to keep track of the sales receipt, whether it is for a warranty return, exchange, or credit return, or simply to manage their finances at home. Very often the receipt cannot be found when needed. The receipt is usually placed in a wallet or purse where it is later or discarded when it becomes a nuisance and is thrown away or lost filed at home. When filed at home, it may be difficult to locate and can be time consuming to find a receipt due to being misfiled or in a previous year's files that have been rotated. Everyone has dealt with finding every receipt except the one actually being searched for at the time.

This can lead to items that are nonreturnable, returned at a discounted rate, or issued a restocking fee. Most warranties can be from one year to a lifetime warranty. Most companies require a copy of the original receipt before receiving warranty services. If the customer is unable to locate the receipt, it is then up to the consumer to pay for services rendered or to purchase a new product to replace the item that is not working properly.

Moreover, in the fast paced world we live in today, so often we get caught up living in the moment and lose track of the time. This can lead to forgotten appointments due to overscheduling, and/or misplacing reminder cards. As an employer, there are costs involved with sending these cards, including employee work time spent in filling out and mailing reminder cards or making reminder phone calls. The employer also has to purchase the reminder cards and pay for the postage to send them to clients. If a client does not show up for an appointment, the employer has then lost the income that would have been produced during that scheduled time. Each person who makes an appointment to receive a service or to meet with someone has the need to keep track of the appointment and to be notified in advance that the appointment is imminent.

In addition, every parent of a school age child should be able to track their student's assignments, due dates of assignments, progress and grades. Due to teachers and school faculty being unable to spend the personal time needed to get this information to parents on a regular basis, parents only receive annual progress reports on their student. Assignments, and graded assignments, are easily lost, misplaced, or forgotten. Thus, the parents do not receive all of the information that may be needed in helping their student receive a good education. By the time the parents do receive this information at the end of a quarter, it is too late to rectify the situation. The student also may loose the ability to get help when needed on specific subjects or assignments due to moving on to different curricula.

A further problem is that parents may also be unaware that their student is in need of monies for school meals until they receive a notice from the school that is sent home with the student. This also can be misplaced or not given to the parents in a timely manner. Thus, the student does not have sufficient monies to purchase needed meals from inaccurate budgeting or from overspending of monies on additional snacks. It would be desirable to have a student's lunch card connected with a transaction processing system that could alarm the parents of the student's meal spending, and that could be reviewed via the Internet.

It should be understood that every school administrator/teacher should be able to have a simple process capable of keeping track of student attendance by day or by class. Every parent should have the capability to review their student's attendance instantaneously and online as needed. Parents may be unaware of a student's attendance unless they inquire about the attendance record, or unless they are home to receive a phone call from the school notifying them that their student did not attend that day. If parents work all day, the phone call can be missed. There is a need for an automatic transaction processing system that electronically compiles and stores student attendance for a particular class or school day.

Record keeping problems are compounded, given that most parents are unaware of school events due to flyers getting lost, thrown away, or the student does not give the flyer to their parents until after the event has occurred. The school may use the postal service to send information concerning problems that a student may be having at the school associated with drugs, alcohol, tobacco, disrespectful behavior to teachers, other students, or property, of which the parents should be made aware. Printing the flyers costs the school education money for paper, print cartridges, design and print time.

Similarly, business personnel need to fill out expense reports for reimbursement or tax purposes. They often have several receipts in their wallet or vehicles that often become a nuisance and get lost of thrown away. It can take several hours of valuable work time to manually fill out an expense report, or to enter expenses into a money management software package. The time spent costs not only the employee's valuable time, but also costs the employer. The receipt can also be accidentally filed in a personal receipts file, which leads to missed business expenses because a receipt could not be located.

In addition, business personnel have a difficult time accurately recording reimbursable mileage on company or personal vehicles. Often personnel simply forget to write down the starting mileage or do not have a sufficient record keeping system, thus resulting in inaccurate mileage records, which can be costly to the employee or to the company for tax purposes.

Automobiles require regularly scheduled maintenance services. Automobile owners often forget to get the recommended service needed because they have forgotten when it was last serviced, lost the sticker in the window, or have misplaced the reminder card they received in the mail. In addition, many businesses do not have the resources to track required vehicle maintenance services that are needed for vehicle reliability. The cost of replacing vehicle parts due to failure to perform regular maintenance can be an unnecessary financial burden for both personal owner and businesses.

Merchants spend millions of dollars each year on receipt printing paper, printers and thermal ribbons. The cost is then passed on to the consumer. Tons of paper is used to print these receipts, most of which are thrown away or filed.

Most people in today's world take some sort of vitamins or prescribed medications for health reasons. Often these medications are forgotten or taken at an incorrect time. People often forget due to losing track of time, loss of mental capability, or simply forgetting. This can lead to not receiving the needed dosage of medications or needed vitamins for a better healthy lifestyle.

When receiving packages from UPS, FEDEX, or local delivery services, sometimes these shipments are missed due to persons not being available to sign for the package. The packages are then sent back to the shipping service center and are then scheduled for re-delivery or held for pickup. This costs the customer, and also the shipping service company, time and money.

Thus, a transaction processing method solving the aforementioned problems is desired.

### SUMMARY OF THE INVENTION

The transaction processing method is a computer-implemented method capable of logging events initiated by a consumer at a point of transaction. The event logging is performed at a transaction processing center. The transaction processing center can log events, such as: receipts generated by a plurality of merchants doing business with the consumer; cash transactions generated at a plurality of cash transaction venues visited by the consumer; credit transactions generated by a plurality of creditors of the consumer; and non-financial events generated at a plurality of non-financial event venues visited by the consumer. The events are reported to the transaction processing center by a plurality of associate members who contract with the center to provide the data. For each consumer, the event data can be stored in journal format on a server and made available for search, retrieval, display, and documentation by a consumer who signs up to receive his/her journal information. The method may include the use of a data communication system having mass storage and Internet working capability, such as memory storage devices having access to the Internet. The events may be financial transactions, e.g., credit, debit card transactions, cash disbursement, electronic cash transactions, automated teller machine transactions, point of sale and e-commerce transaction services, or the like.

Events may be appointments, assignments, tasks, or other activities and personal transactions defined by the user. An event may also be an alarm, or a reminder of a future event. An event database may be provided, managed and maintained by using, e.g., magnetic strip media, SmartCard digital memory media, RFID technology, computer and Web-based application interfaces, stationary and mobile card interface devices, the Internet, and the like. The user may possess handheld digital storage media, i.e., a journal card, to access his/her event records.

Records in the event database can be encrypted and transmitted to a secure server using global electronic communications, e.g., the Internet, wired/wireless communication methods, and the like. The secure server archives the events in a sequential database by date and time of event, and in a relational database based on event type, category, subcategory or group.

The user can access and process the archived data to provide “journal” activity reports of past events and, when applicable, an expense categorization of the events. The user may setup alarms and reminders for upcoming events. The user may also download and merge the archived data with software programs, such as Microsoft Money®, Quick Books®, Peachtree®, Franklin Day Planner®, Outlook®, and the like.

Upon remote connection to the event database server, the user may synchronize the journal card memory device with the user's local computer database files. The user can then create an electronic softcopy of the event transactions at the Point of Transaction. The user can also transmit the electronic copy to a secure server location. Individual components of each transaction can be broken down, categorized and stored in their respective database.

Moreover, access to the transaction database(s) may be provided over the Internet. Using a Web-enabled device, the user can interact with the data for many different purposes, such as printing sales receipts, importing transaction log files into financial software, further categorizing transaction details, performing data searches, creating reports, and the like.

The user can setup alarm and event notification for financial limits and future events. Log file search engines can be developed that can permit merchants to produce demographic and product purchase profiles based on the transaction log data.

These and other features of the present invention will become readily apparent upon further review of the following specification and drawings.

### BRIEF DESCRIPTION OF THE DRAWINGS

FIG. 1 is a block diagram of components used in a transaction processing method according to the present invention.

FIG. 2 is a block diagram of components and steps in transaction processing and management according to the transaction processing method of the present invention.

FIG. 3A is a chart showing exemplary online signup entry fields in a transaction processing method according to the present invention.

FIG. 3B is a chart showing an exemplary member ID associated with a database record in a transaction processing method according to the present invention.

FIG. 3C shows a subscriber associated accounts table in a transaction processing method according to the present invention.

FIG. 4A shows a transaction association log record in a transaction processing method according to the present invention.

FIG. 4B shows a transaction association log in a transaction processing method according to the present invention.

FIG. 5A illustrates a transaction item record in a transaction processing method according to the present invention.

FIG. 5B is a transaction item log file in a transaction processing method according to the present invention.

FIG. 6A is a summary log file in a transaction processing method according to the present invention.

FIG. 6B is a transaction payment log in a transaction processing method according to the present invention.

FIG. 7A is a transaction schedule record in a transaction processing method according to the present invention.

FIG. 7B is a journal card transaction schedule log file in a transaction processing method according to the present invention.

FIG. 8A is a transaction association log in a transaction processing method according to the present invention.

FIG. 8B is a transaction journal record in a transaction processing method according to the present invention.

FIG. 8C is a transaction journal log file in a transaction processing method according to the present invention.

FIG. 9A is a transaction trip record in a transaction processing method according to the present invention.

FIG. 9B is a transaction association log in a transaction processing method according to the present invention.

FIG. 9C is a transaction association log in a transaction processing method according to the present invention.

FIG. 9D is a transaction trip log file in a transaction processing method according to the present invention.

FIG. 10A is a transaction maintenance record in a transaction processing method according to the present invention.

FIG. 10B is a transaction maintenance record in a transaction processing method according to the present invention.

FIG. 10C is a transaction maintenance log file in a transaction processing method according to the present invention.

FIG. 10D is a transaction schedule log file in a transaction processing method according to the present invention.

FIG. 10E is a transaction maintenance record for manual entry in a transaction processing method according to the present invention.

FIG. 11A is an attendance transaction record in a transaction processing method according to the present invention.

FIG. 11B is an attendance transaction log file in a transaction processing method according to the present invention.

FIG. 12A is a transaction payment log in a transaction processing method according to the present invention.

FIG. 12B is a transaction association log record in a transaction processing method according to the present invention.

Similar reference characters denote corresponding features consistently throughout the attached drawings.

### DETAILED DESCRIPTION OF THE PREFERRED EMBODIMENT

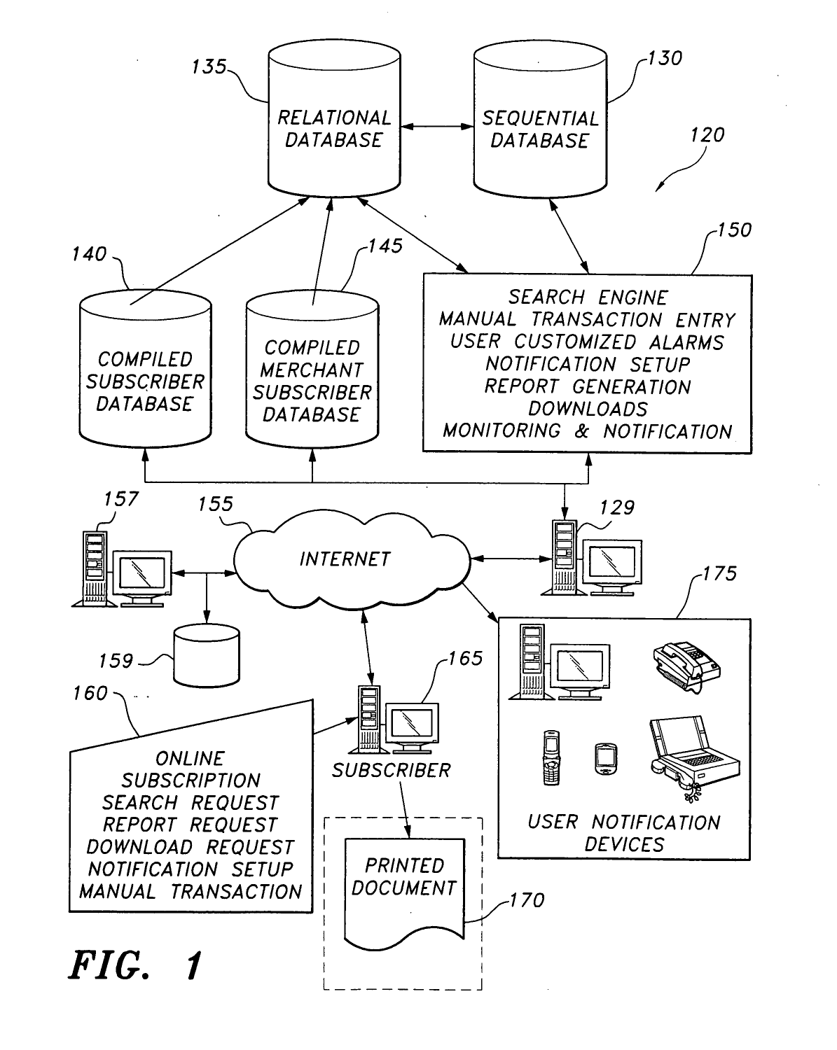

As shown in FIG. 1, the present invention, a transaction processing method, is a computer-implemented method capable of logging events initiated by a consumer/user, i.e., subscriber 165, at a point of transaction. The event logging is performed at a transaction processing center 120. The transaction processing center 120 can log events, such as: receipts generated by a plurality of merchants doing business with the consumer 165; cash transactions generated at a plurality of cash transaction venues visited by the consumer 165; credit transactions generated by a plurality of creditors of the consumer; and non-financial or personal events generated at a plurality of non-financial event venues visited by the consumer 165.

The events are reported to the transaction processing center 120 by a plurality of associate members who contract with the center 120 to provide the data. For each consumer 165, the event data can be stored in journal format on a server 129 and made available for search, retrieval, display, and documentation by a consumer 165 who signs up, i.e., subscribes, to receive his/her journal information.

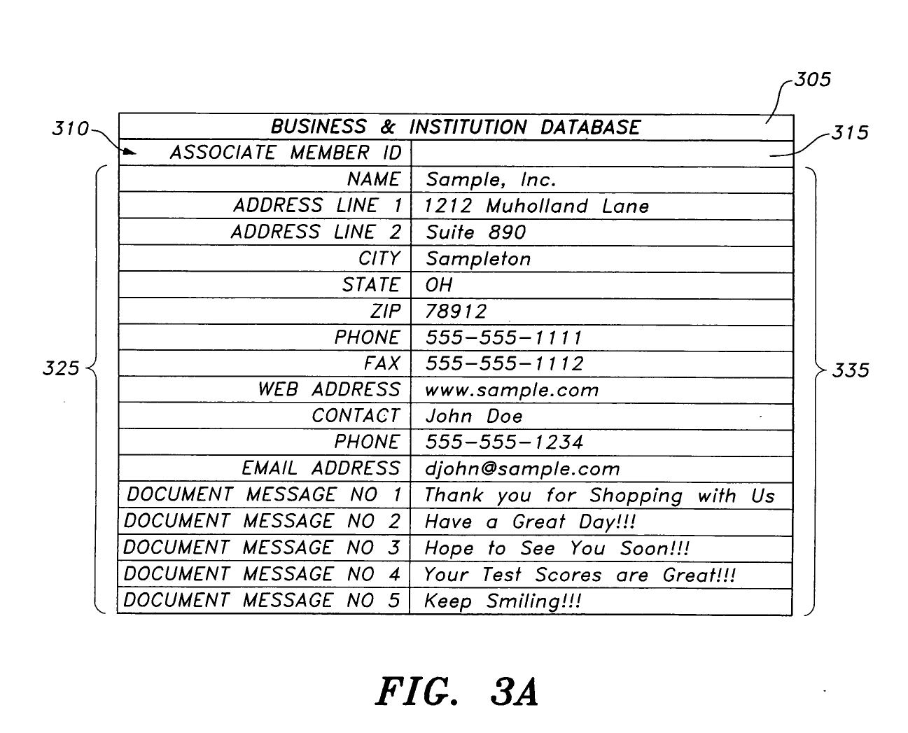

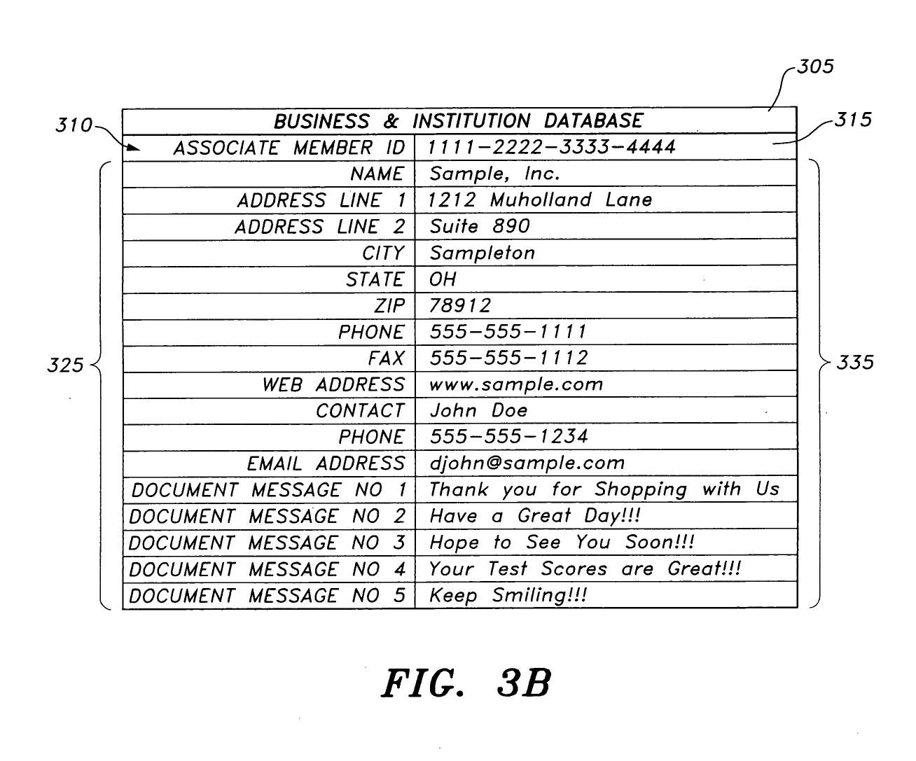

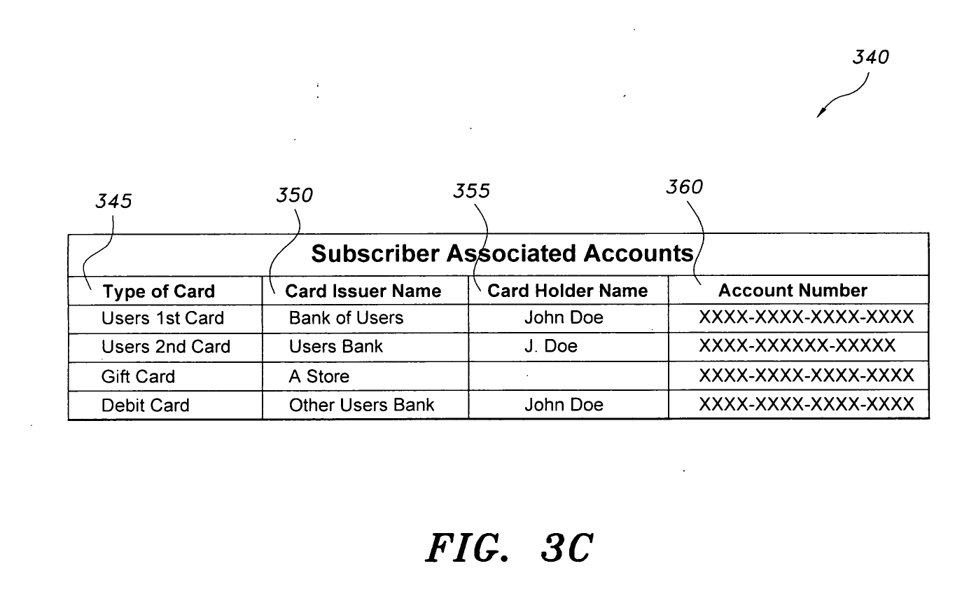

The consumer/subscriber 165 may create an account with the transaction processing center 120 by utilizing an Internet connection to register online and agree to the terms and conditions of use. During the registration process, the subscriber 165 is asked to provide information about each form of payment, e.g., credit, debit, gift, and the like, that the subscriber 165 wishes to have automatically monitored and associated to the subscriber's account when a corresponding transaction is processed. As shown in FIG. 3C, the information requested is stored in a subscriber associated accounts table 340. Required entry fields are Type of Card 345, Card Issuer Name 350, Card Holder Name 355, and Account Number 360. With this information, the transaction processing center 120 can monitor all incoming transactions and compare the form of payment information to the subscriber information on file. When a match is found, the incoming transaction is associated to the subscriber 165, thus, advantageously, providing a way of maintaining financial transactions without requiring a JournalCard membership card swipe by the user 165.

According to the method, during the registration process the user 165 is requested to take a short, multiple choice survey where questions will be asked, such as: gender; hobbies; interests; favorite vacation spots; etc. The subscriber 165 may skip this survey, if so desired.

Upon completion of a registration form online, the subscriber 165 is assigned a JournalCard membership ID number and the subscriber's online account with the transaction processing center 120 is activated. A welcoming e-mail explaining the features and benefits of the service, as well as providing account and customer service contact information, is sent to the subscriber 165. A subscription packet containing the user's membership card, i.e., JournalCard, is automatically sent by the service to the user 165.

Once registered, the subscriber 165 may manage his/her account by customizing his/her level of automatic transaction recording and setting up of parameters for alarms and notifications.

The subscriber 165 may also perform searches and create downloadable reports. Subscribers 165 may be required to pay a periodic, e.g., monthly, subscription fee for benefits and services provided by the transaction processing center 120. The method provides for fast transaction search and retrieval by associating data fields within a transaction log database with data fields of related user databases.

It should be understood that the transaction processing method provides a subscription-based business process for tracking, monitoring, processing and managing daily events in the life of the subscriber/consumer 165. Events may be, but are not limited to, such categories as merchant and service provider sales, event scheduling, journal logging, and academic progress logging.

Throughout this document, the term “event” should be understood to encompass an occurrence of a business or personal nature capable of being recorded, such as, but not limited to, communication involving two or more people that affects all those involved; a business agreement or exchange; an agreement between a buyer and a seller for the exchange of goods or services for payment; an action that requires the transfer of funds from one party to another, and the like.

A “transaction” is triggered by an event and may comprise, e.g., sales receipts; credit receipts; banking transaction receipts; schedule log books; appointment books; maintenance logs; mileage logs; security access logs; attendance logs; progress reports; assignments; task lists, and the like.

A “Point Of Transaction (POT)” generally comprises a location where a transaction takes place, such as: a point of sale (POS); a retail shop, including a checkout counter in a shop or a variable location where a transaction occurs; the moment an exchange of funds has taken place; the moment an agreement, appointment, or arrangement has been logged; when an appointment is entered into a scheduling program or written in an appointment book, and the like.

Additionally, the method may include the use of a data communication system having mass storage for databases, such as sequential database 130, relational database 135, compiled subscriber database 140, compiled merchant subscriber database 145, and the like, and Internetworking capability, such as memory storage devices; servers, e.g., merchant server 157 and transaction processing server 129; Web-enabled user devices, such as devices 175; all having access to the Internet 155.

According to the transaction processing method, events may be financial transactions, e.g., credit or debit card transactions, cash disbursement, electronic cash transactions, automated teller machine transactions, point of sale and e-commerce transaction services, or the like.

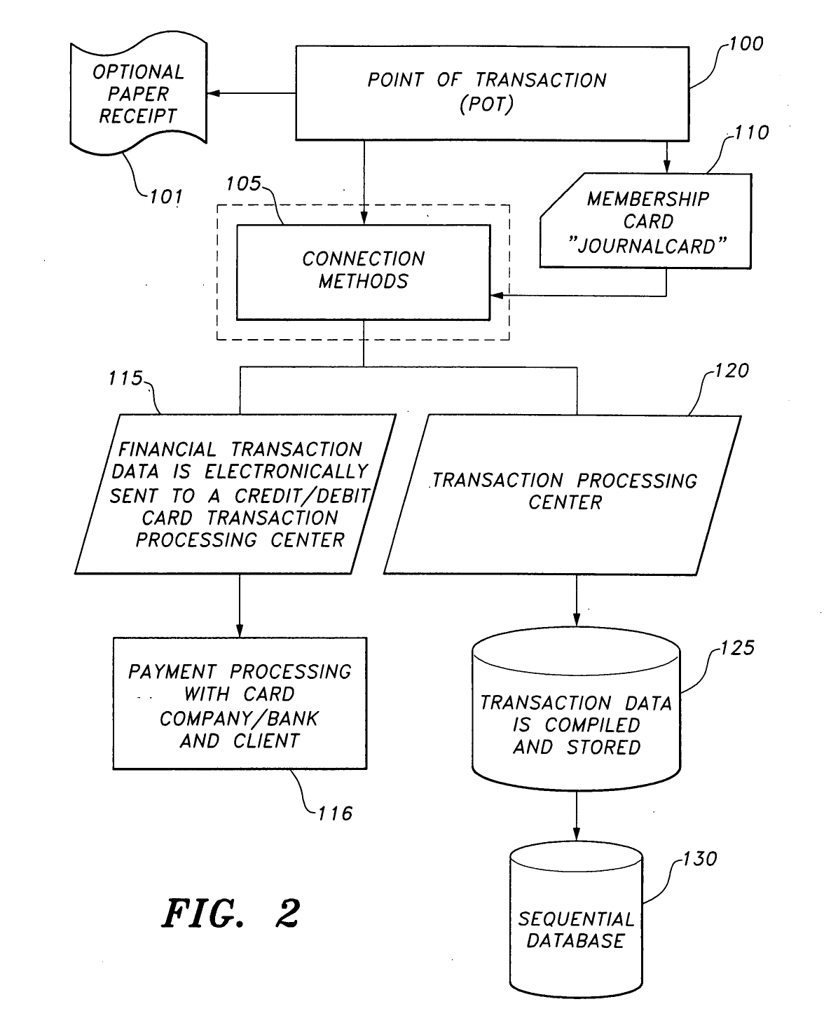

Additionally, events may be appointments, assignments, tasks, or other activities defined by the user 165. An event may also be an alarm, or a reminder of a future event. An event database may be provided, managed and maintained by using, e.g., magnetic strip media, SmartCard digital memory media, RFID technology, computer and Web-based application interfaces, stationary and mobile card interface devices, the Internet 155, and the like. As shown in FIG. 2, the user 165 may possess handheld digital storage media, such as a journal card 110, to access his/her event records.

In addition to the user 165, an associate member, who is generally a business, institution, or some other service provider related to the user transactions being logged, and a journal card transaction processing center 120 participate in the process. Moreover, an Associate member can be a business or institution that provides goods and services to customers, students and clients. The transaction center operator may contract with the providers of goods and/or services to send transaction records between the providers and their customers, i.e., users 165, to the transaction center 120. The transaction center operator may then contract with the customers 165 to allow the customers 165 to have access to journals created by processing done at the transaction center 120. Each “JournalCard” Associate Member must be certified to process journal card transactions. The certification process verifies the Associate Member's ability to duplicate and electronically deliver Journal card transactions to the processing center. Once certified, every transaction performed between the Journal card associate Member and their customers, students, or clients will be automatically recorded at a Journal Card processing center.

A service provider, i.e., an associate member, may initiate certification by signing-up online with the transaction processing center. As shown in FIGS. 3A and 3B, the associate member may be required to supply the data identified by field identifiers 325 in the business and institution database (BI database) 305. The required field values may be entered by the associate member. A record is retained in the entry fields 335 of the BI database 305. It should be noted that, at the time of initial sign-up by the associate member, an associate member ID 310 has not been assigned yet, and that the associate member ID field 315 is null, i.e., blank.

After certification of the service provider, the transaction processing center can provide an application program interface (API) add-on module or some other type of software upgrade that can allow communication of the service provider's transaction processing software with the transaction processing center 120. It is contemplated that interoperability of the service provider's transaction processing software with the transaction processing center processor, such as server 129, can allow for processing of business sales transactions, appointment schedules, and other day-to-day operational records. Moreover, the API can provide and/or facilitate an electronic duplicate of transaction data, compilation of the transaction data, connectivity to the transaction processing center 120, and communication, i.e., transmission and reception, of the transaction data via the connection to the transaction processing center computing resources, such as server 129. Additionally, service providers seeking certification may have interface devices, such as a magnetic stripe reader, and a data connection, such as Internet connection 155 to the transaction processing center server 129.

As shown in FIG. 3B, upon completion of the certification process, the associate member is assigned a member ID number that is placed in the ID field 315 of the business record 305. A special identifying symbol, e.g., “JournalCard,” may be applied to associate members and the entire certification process. A certified member may apply the “JournalCard” identifying symbol/logo to doors, check stands, sales terminals, and the like. End-user client transactions of a certified “JournalCard” Associate Member can then be logged at the “JournalCard” processing center 120.

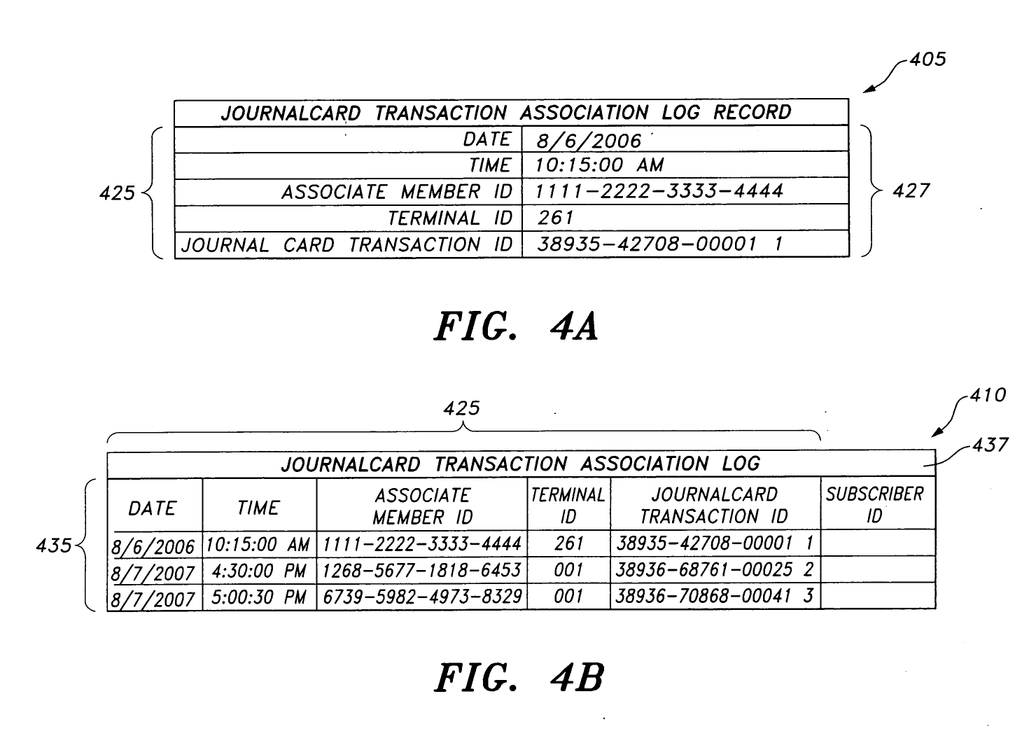

Referring to FIGS. 4A and 4B, when the “JournalCard” transaction processing center 120 receives a transaction from the “JournalCard” Associate Member, a transaction date and time are entered into a log record, such as log record 405. Additional log record entries 427 include Associate Member ID, and Terminal ID, as specified by the field identifiers 425. The transaction processing center 120 uses the aforementioned log record entries to create and assign a “JournalCard” transaction ID, which is also entered in the log record. FIG. 4B shows a transaction association log file 410 having field descriptors 425, their associated entries 435 per transaction, and a subscriber ID column 437. It should be noted that the transaction association log 410 is a compilation of a plurality of records, such as journal card transaction association log record 405.

Transactions may be categorized into a plurality of transaction types as they are compiled 125 and logged into the sequential database 130. The transaction processing method may provide a plurality of main categories, such as, without limitation: Financial, Scheduling, Journal Logging, Academic Logging, and the like. Financial events may include department or retail store sales receipts 101, credits, returns, or exchanges. Additional financial events may include banking transactions, such as credit and debit card transactions, cash disbursements, electronic cash transactions, automated teller machine transactions, point of sale, and e-commerce transaction services. Financial transaction data can be electronically sent to a credit/debit card transaction processing center 115. Payment processing can be completed using the card company/bank and client 116.

The transaction processing center 120 can compile and log every line item on a sales receipt, credit, return, or exchange transaction with the aforementioned “JournalCard” Transaction ID, an Item SKU number, Item Description, Quantity Purchased, Purchase Cost for Each Item, and the like. It should be understood that in the event of a CASH, CHECK or similar type transaction where an account number does not associate the client to a transaction, the client can swipe his/her physical JournalCard 110 to provide the account number that associates the client to the transaction.

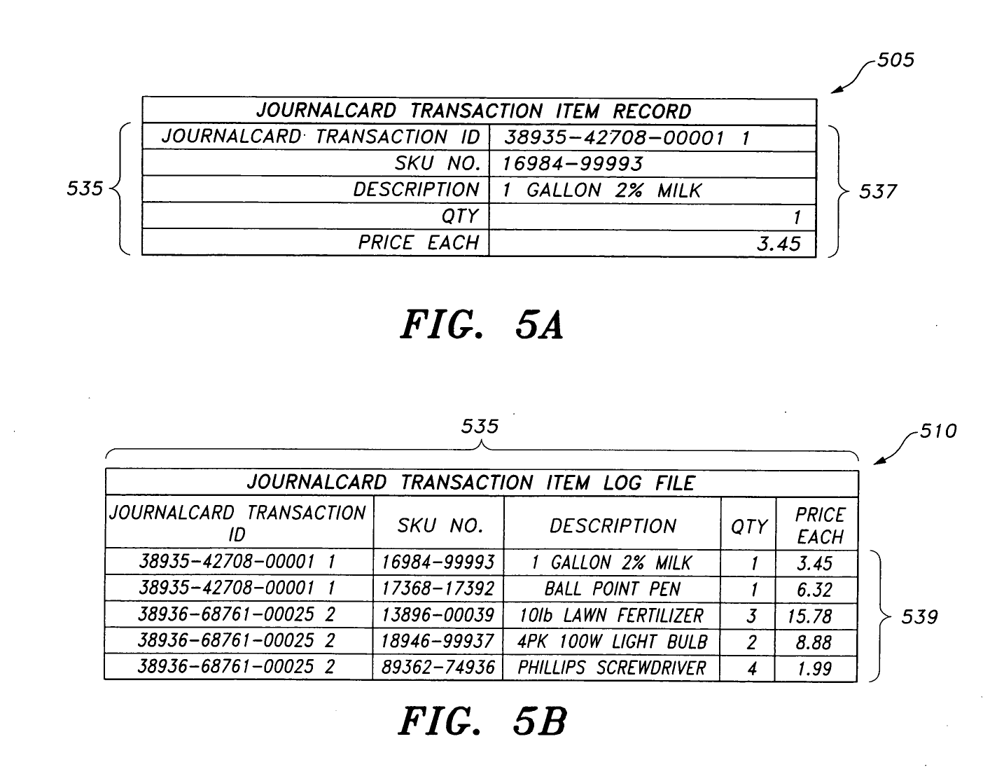

As shown in FIG. 5A an individual item record 505 may have field identifiers 535 and their corresponding entry fields 537. As shown in FIGS. 5A and 5B the transaction item log file 510 may be comprised of a plurality of item records 505 as unique items arranged in rows 539.

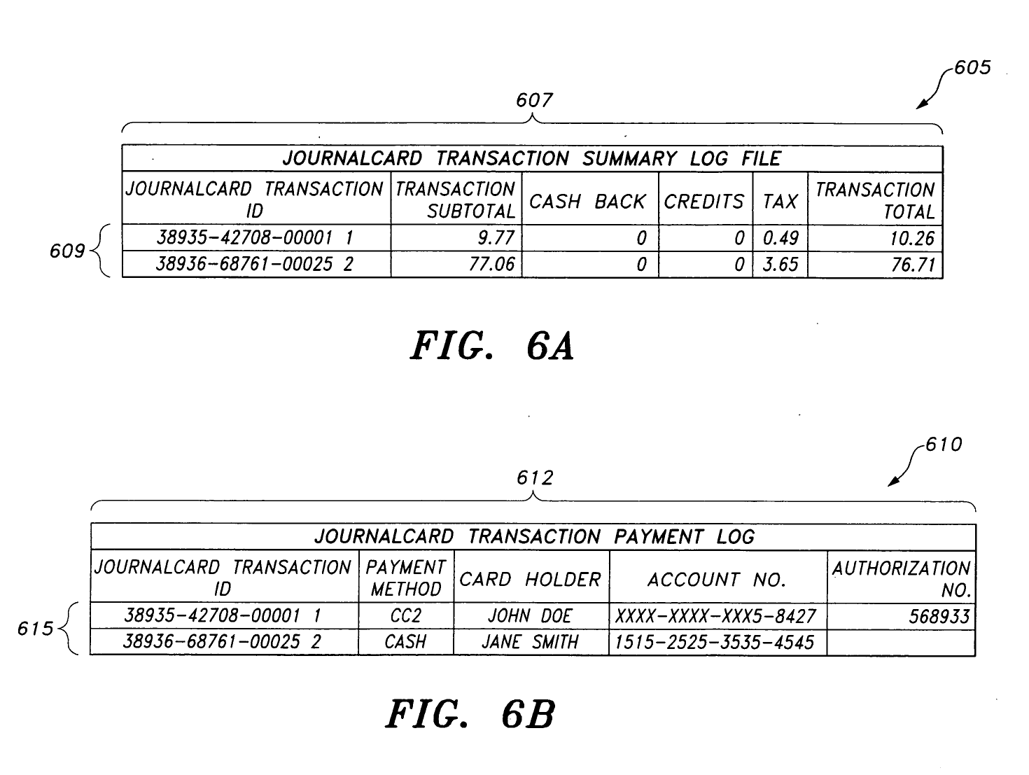

As shown in FIG. 6A, a financial transaction may have summaries and totals recorded in a transaction summary log file 605, regardless of its type. The summary can be associated with the “JournalCard” Transaction ID and sequentially logged in the Transaction Summary log file 605 having field identifiers 607 and corresponding entries 609.

A financial transaction requires a record of form of payment or credit, as performed in millions of credit cards sales and credit transactions per day. As shown in FIG. 6B, the payment information can be associated with the “JournalCard” Transaction ID and sequentially logged in a transaction payment database. The transaction payment log 610 has field identifiers 612, including the transaction ID, payment method, cardholder, account number, and authorization number. Corresponding field entries 615 are entered according to the recorded payment data.

Scheduling transaction types may comprise health appointments, medical appointments, personal service appointments, work assignment due dates, task due dates, vehicle and equipment maintenance schedules, school assignment due dates, family and friend event scheduling, and the like.

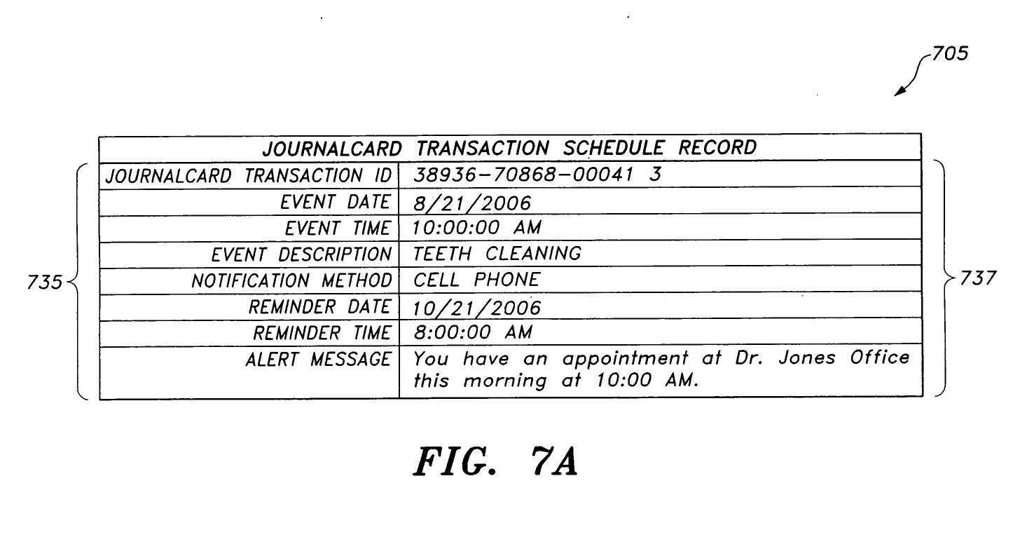

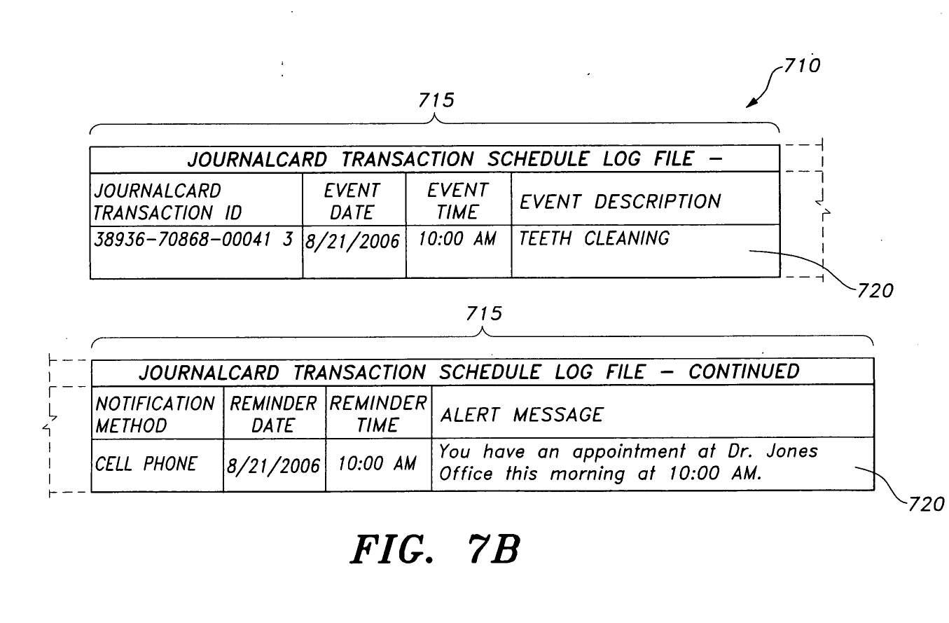

A “JournalCard” terminal may be provided to allow an Associate Member to log a new event. The transaction processing method allows the Associate Member to prepare a transaction appointment schedule. After the associate member has prepared the appointment schedule, the subscriber 165 can swipe his/her physical “JournalCard” to initiate transfer of the appointment schedule data to the transaction processing center 120. The “JournalCard” transaction processing center receives the transaction data and assigns the “JournalCard” transaction ID of the user, i.e., subscriber 165. The transaction processor, i.e., server 129, then compiles and logs every parameter of an event schedule, such as Event Date, Event Time, Event Description, Notification Method, Reminder Date, Reminder Time, Alert Message, and the like. As shown in FIG. 7A, an individual transaction schedule record 705 is comprised of field identifiers 735, which include transaction ID, event date, event time, event description, notification method, reminder date, reminder time, and alert message. The recorded data is populated in the associated fields 737. As shown in FIG. 7B, a transaction schedule log file 710 has field descriptors 715 spanning multiple columns so that individual rows can contain the field data 720 according to each scheduled transaction ID.

The “JournalCard” subscriber 165, i.e., user, has the ability to manually enter records online to the Schedule Log through the user's Internet account. The online entry method, advantageously, may be utilized when the merchant or service provider is not a “JournalCard” Associate Member, or when the appointment schedule has been established after leaving the merchant or provider's office, or when the “JournalCard” subscriber 165 is autonomously establishing schedules that have nothing to do with a merchant or provider. Examples may be sales appointments for a salesperson, medication schedules for an individual, and the like.

The transaction processing center 120 provides an interactive Web browser-based user interface through an Internet connection accessible to the subscriber 165, so that the subscriber 165 may search, view, manipulate, report and download logged transactions. The “JournalCard” subscriber 165 can access his/her “JournalCard” account online through an Internet web page. The user 165 can select manual Schedule Log entry and prepare the transaction appointment schedule on a form provided by the web page. Once the subscriber 165 submits the Schedule, the “JournalCard” transaction processing center receives the transaction and assigns the “JournalCard” transaction ID. Because the transaction is not being made from a “JournalCard” Associate Member terminal, the Associate Member ID field is left blank. Nevertheless, the transaction processor can compile and log every parameter of an event schedule, event date, event time, event description, notification method, reminder date, reminder time, alert message, and the like. The user 165 can associate the manually entered transaction log entry with event alarm notification procedures.

The transaction processing center 120 can process a variety of journal events, such as events for future reference, vehicle mileage events, vehicle and equipment maintenance events, security access events, time card events, and attendance events. A plurality of Journal Log types may be provided, such as an Event Journal, a Trip Journal, a Maintenance Journal, an Attendance Journal, an Access Journal, and the like. Each type of Journal Log entry may be processed differently.

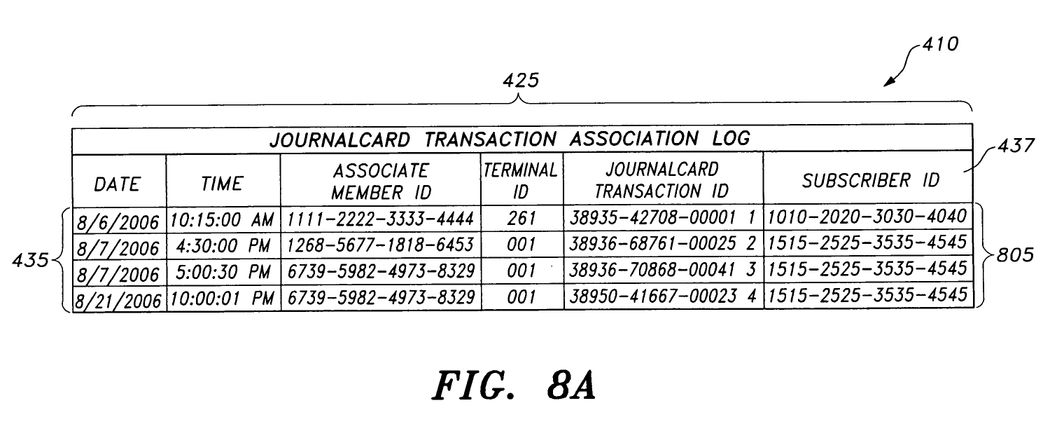

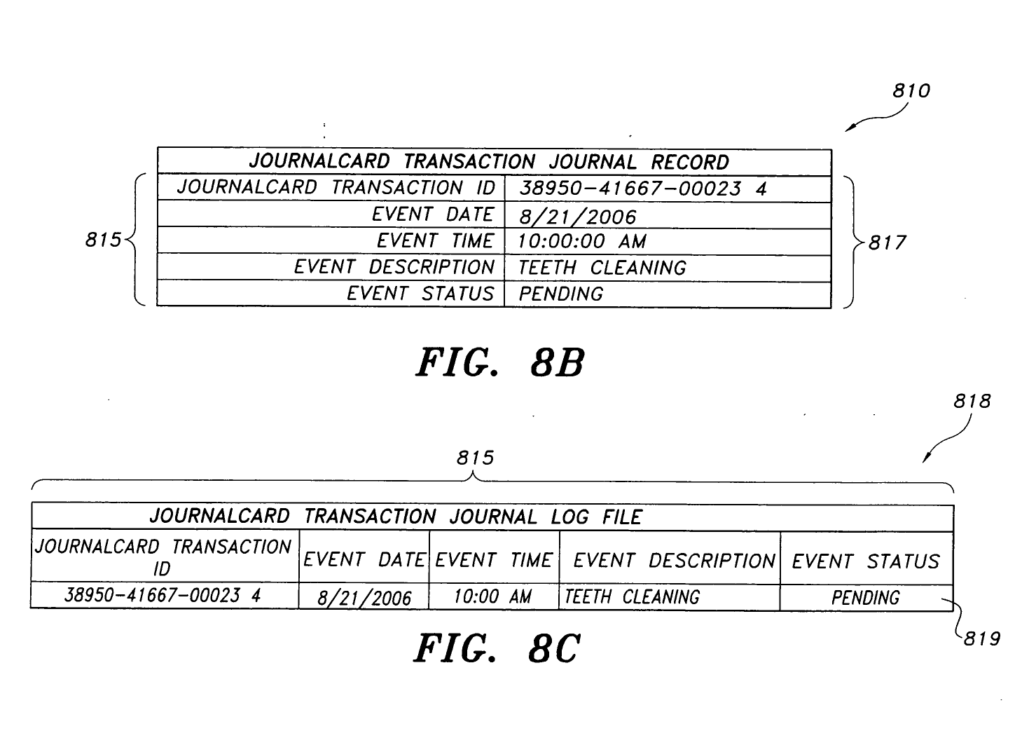

An event journal comprises events or tasks that have been completed but are still required for future reference. As shown in FIGS. 7A and 8A, when a Schedule Record is past its Event Date and EventTime, the transaction processing center 120 automatically copies the original transaction association record, changes the transaction Date, Time, and “JournalCard” transaction ID of the copied record, then adds the modified record to the transaction association log. As most clearly shown in FIG. 8A, both the original transaction and the new transaction record are recorded in the transaction association log 410. The transaction association log 410 is comprised of field identifiers 425 in the columns and corresponding field entries 435 wherein each transaction populates a separate row. The subscriber ID column 437 is populated by a unique subscriber identifier 805 associated with each individual subscriber 165.

As shown in FIG. 8B, simultaneously, required data fields from the original Schedule record are automatically copied from the Schedule log to the Event Journal log and marked as status “pending’. The transaction journal record 810 is comprised of field descriptors 815 and their corresponding data entries 817. As shown in FIG. 8C, a transaction journal log file 818 is comprised of field descriptors 815 and corresponding data, including event status 819. A plurality of transaction journal records 810 may be appended to the journal log file 818.

The “JournalCard” Subscriber 165 can be notified via email of a Journal Log record that is status “pending”. The subscriber 165 may go online, log onto the subscriber's “JournalCard” account and post the pending transaction or delete the transaction.

In the instance where a previous schedule was not arranged for an event, the “JournalCard” subscriber 165 may still have the event logged for future reference. The method provides for logging a new event using an Associate Member terminal. The “JournalCard” Associate Member can prepare the transaction as if it is an appointment schedule, except that the Date and Time fields will be the current date and time. The “JournalCard” user 165 can initiate transaction processing with his/her physical “JournalCard”. The “JournalCard” transaction processing center receives the transaction and assigns the “JournalCard” transaction ID. The transaction processing center then compiles and logs every parameter of an event schedule. Momentarily the time advances beyond the Event Date and Event Time. When the event date and time has been reached, the transaction processing center can convert the scheduled event into a pending “JournalCard” Journal record.

A trip journal may be created in which travel events are logged. This service to the subscriber 165 requires vehicles be equipped with OnStar® or other GPS-based system having continuous access to a remote monitoring center. The “JournalCard” subscriber 165 provides his/her subscriber ID number and authorizes the vehicle monitoring center to perform a “JournalCard” transaction to record odometer mileage, runtime hours, and waypoints. A waypoint is a GPS coordinate or physical address of the vehicle location. When the vehicle engine starts, the remote monitoring center automatically creates a “JournalCard” transaction. This transaction comprises Date, Time, Associate Member ID, Terminal ID, Subscriber ID, Vehicle ID, Odometer Reading, Runtime Hours, current waypoint, and the like. When the vehicle engine stops, the remote monitoring center automatically creates a separate “JournalCard” transaction. The separate “JournalCard” transaction contains Date, Time, Associate Member ID, Terminal ID, Subscriber ID, Vehicle ID, Odometer Reading, Runtime Hours, current waypoint, and the like. The “JournalCard” transaction processing center receives the transaction and assigns the “JournalCard” transaction ID. The transaction processor then compiles and logs every parameter of the Trip Journal.

According to the transaction processing method, a “JournalCard” subscriber 165 has the capability to manually log records to the Trip Journal by entering the data in an online web account. Manual entry may be required when a remote monitoring service is not available for the vehicle. For manual entry, the “JournalCard” subscriber 165 accesses a web page having the required data entry form, e.g., a manual Trip Log Form. The user 165 can then select and prepare each engine start and stop transaction, comprising the aforementioned trip journal fields. Upon completion of the trip form, the “JournalCard” transaction processing center receives the transaction and assigns the “JournalCard” transaction. It should be noted that the Associate Member ID field is left blank.

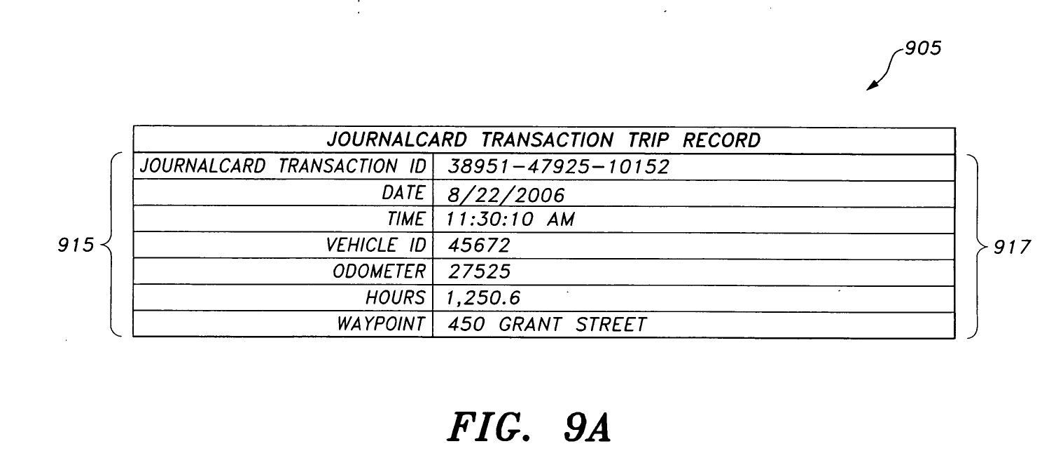

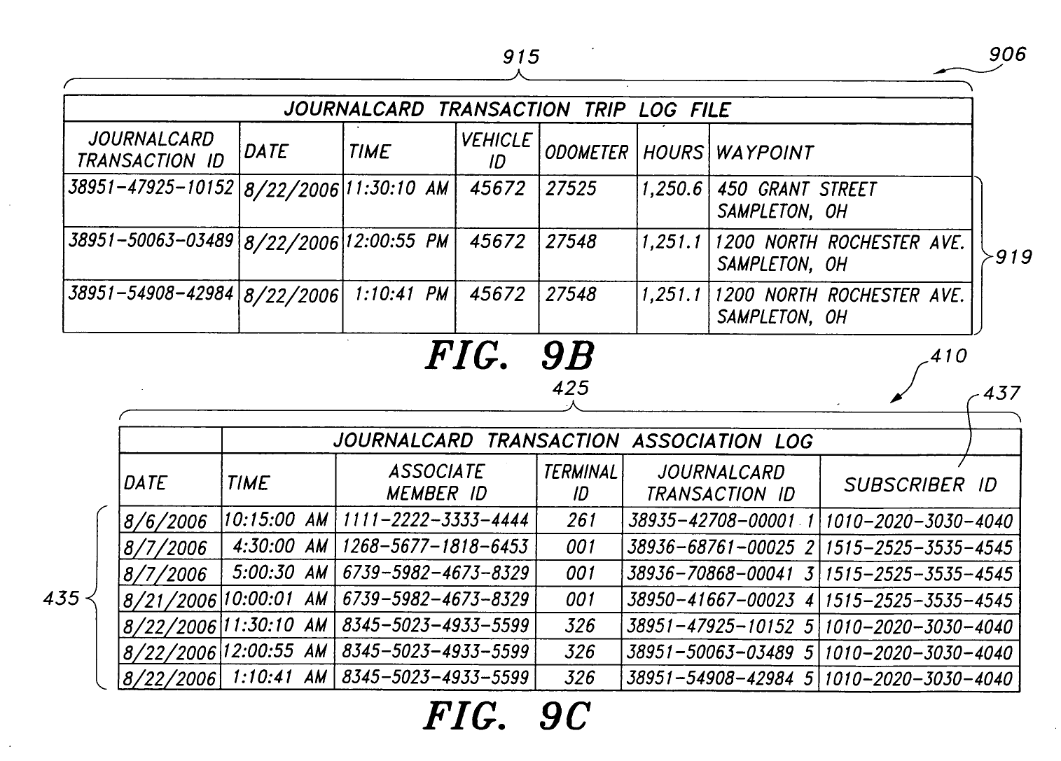

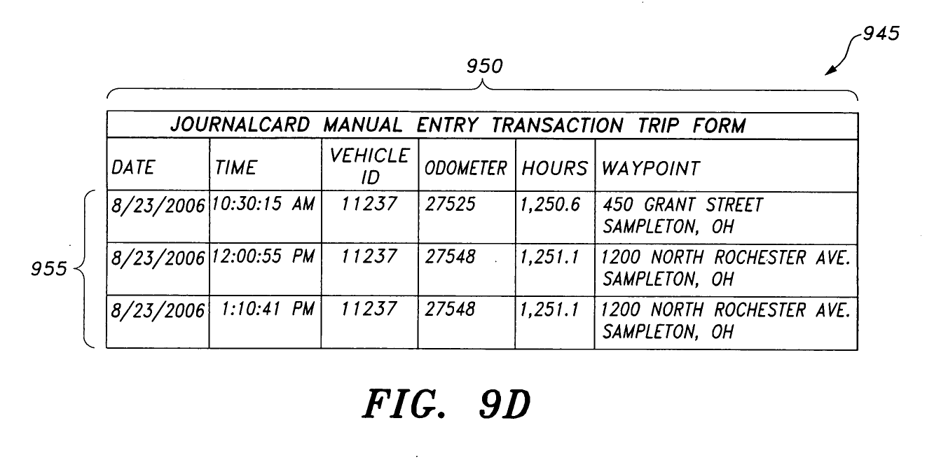

The transactions association log uses the current date and time. The Trip Journal records the events with the date and times entered by the subscriber 165 for each event. The transaction processor then compiles and logs the Trip Journal record event fields. As shown in FIG. 9A, an individual Trip record 905 may comprise field identifiers 915 pertaining to trip data and the associated data entries 917. As shown in FIG. 9B, a transaction trip log file 906 comprises field identifiers 915 spanning columns so that a plurality of trip records 919 may be entered.

As shown in FIG. 9C, the Association Log file 410 can continuously update transactions for each event for each associate member.

As shown in FIG. 9D, the JournalCard Manual entry Transaction Trip form 945 comprises field descriptors 950 and corresponding entries 955.

Transaction processing can record maintenance performed and schedule future maintenance appointments. A Maintenance Journal record and a future appointment Schedule record may both be provided with the same JournalCard transaction ID.

The system is capable of automatically recording vehicle or equipment maintenance by associating a maintenance record with the usual financial transaction that follows the maintenance event. With or without a financial transaction event, the service provider, i.e., “JournalCard” Associate Member, may use their existing transaction processing software with the “JournalCard” API Add-on module to record vehicle and equipment maintenance.

The “JournalCard” Associate Member prepares the transaction maintenance journal. The “JournalCard” Subscriber 165 initiates transaction processing with his/her physical JournalCard 110. The “JournalCard” transaction processing center 120 receives the transaction and assigns the “JournalCard” transaction ID. The transaction processor then can compile and log every parameter of a maintenance record, such as Date, Time, Vehicle or Equipment ID, Vehicle Odometer Reading, Runtime Hours, Maintenance Description, Notification Method, Reminder Date, Reminder Time, Notification Method, Alert Message, and the like.

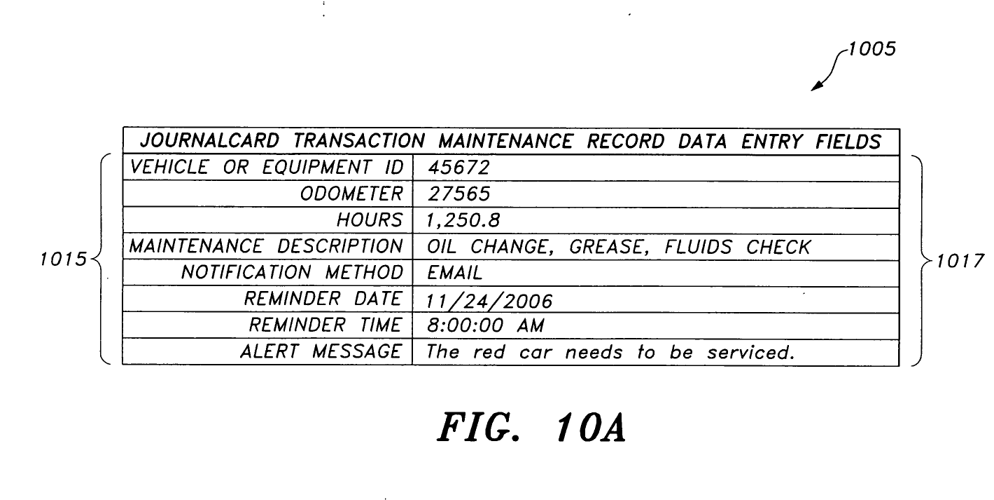

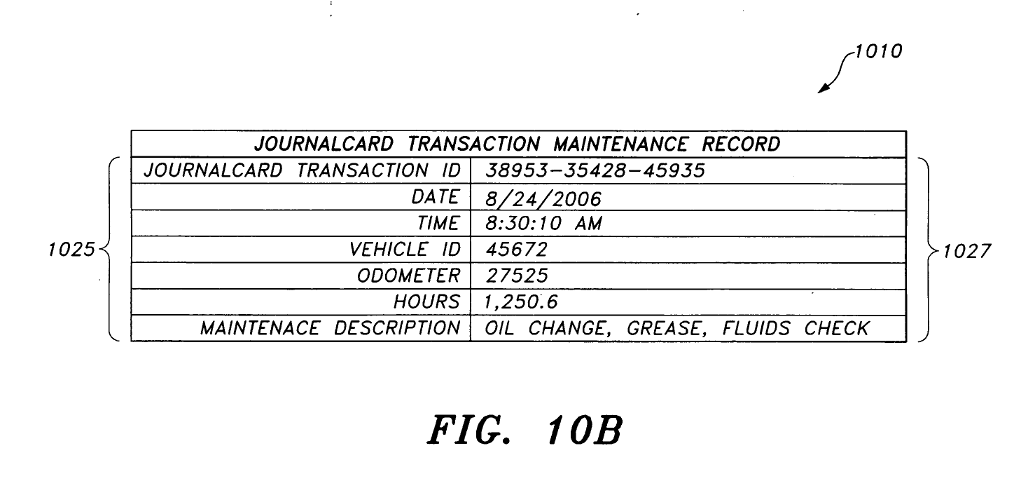

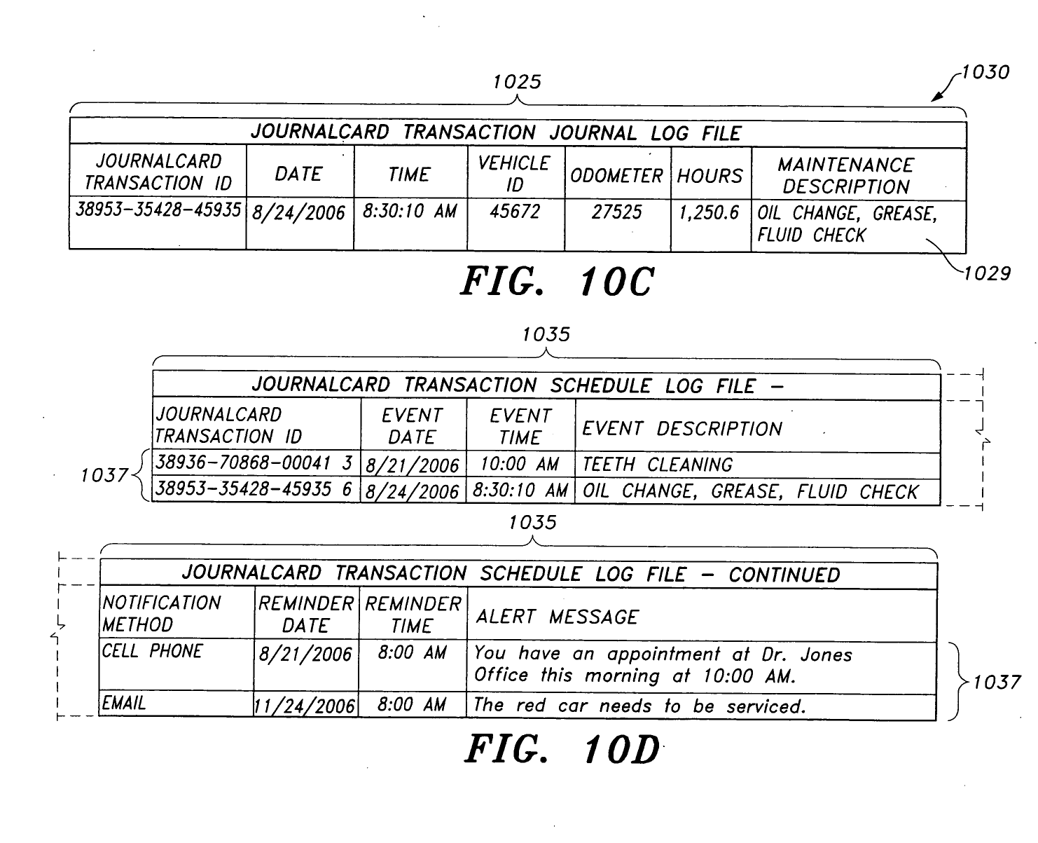

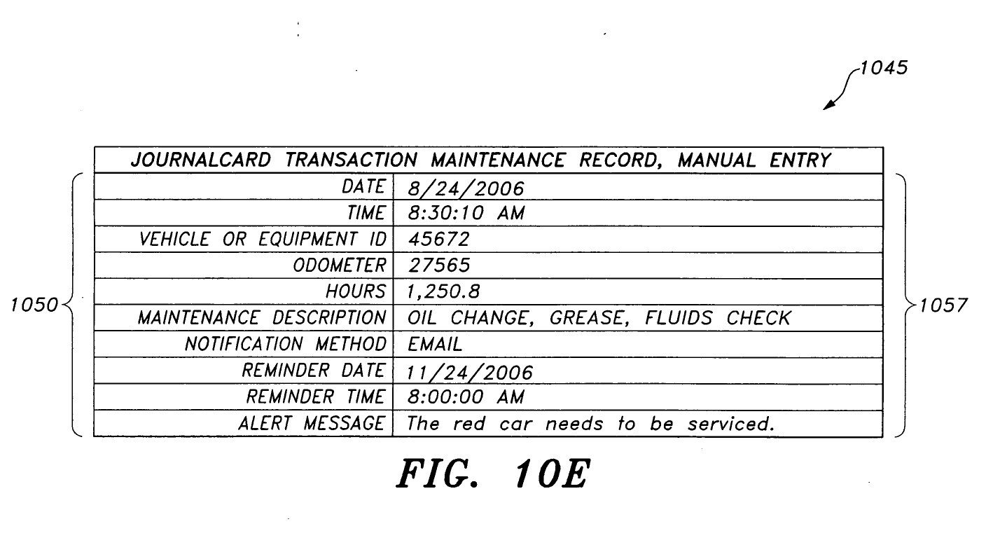

As shown in FIG. 10A, all parameters entered by the “JournalCard” Associate Member for a Maintenance Journal record 1005 are described by field descriptors 1015 for corresponding entry in fields 1017. As shown in FIG. 10B, an individual maintenance record 1010 may comprise field descriptors 1025 and corresponding data entry fields 1027.

Referring to FIG. 10C, the Maintenance Journal Log File 1030 may comprise field descriptors 1025 and their corresponding data entries, including a maintenance description 1029.

Referring to FIG. 10D, the transaction schedule log file for maintenance type events has Field descriptors 1035 and data entry field 1037.

The transaction processor 129 can automatically create a new Schedule from specific fields entered by the “JournalCard” Associate Member. That is to say, the Notification Method, Reminder Date, Reminder Time, and Alert Message may be utilized to create a new schedule.

Referring to FIG. 10E, just as in the other events discussed above, maintenance journal events may be manually entered by a subscriber 165, who uses a maintenance form 1045 available from the manual entry web page. The manual entry maintenance record 1045 comprises field descriptors 1050 describing maintenance parameters and their respective data entry fields 1057. The transaction processing center 120 receives the transaction and assigns the “JournalCard” transaction ID. The AssociateMember ID field is left blank. The transactions association log uses the current date and time. The Maintenance Journal records the events with the date and times entered by the subscriber 165. The transaction processor then compiles and logs the required parameters, i.e., fields, of a Maintenance Journal event record and associated event schedule for future reminders and alerts.

Additionally, attendance and access journals can be provided for by the transaction processing method. For example, as the “JournalCard” subscriber 165 enters and leaves a school building and/or classroom, the user 165 swipes the user's physical JournalCard 110 at a magnetic strip reader located near the entrance. An attendance roll software transaction package of the school, institution, worksite, or the like, can automatically prepare a “JournalCard” transaction with the same identifying and time tagging fields discussed above in order to record access to a secure area, such as a building or specified location. A user time card entry may also be provided in the transaction record.

The “JournalCard” transaction processing center receives the transaction and assigns the “JournalCard” transaction ID. The transaction processor then compiles and logs every parameter, i.e., field, of the Attendance & Access Journal.

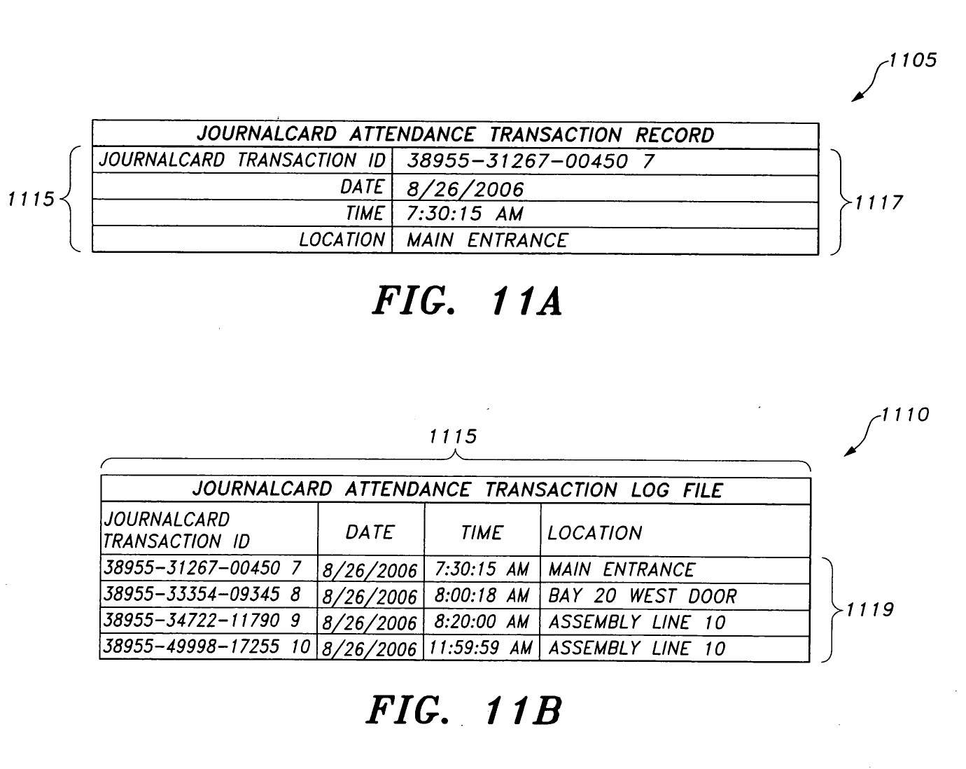

Referring to FIG. 11A, an exemplary Attendance and Access Transaction Record 1105 comprises ID, Date, Time, and Location field descriptors 1115 and their corresponding entry fields 1117. As shown in FIGS. 11A and 11B, the attendance transaction log file 1110 may comprise a plurality of attendance transaction records 1105 arranged in rows 1119. In a similar manner to the aforementioned journal records, the attendance and access journal can comprise fields relevant to attendance and access, such as attendance and security levels. Moreover, in an academic setting, grades, test scores, progress reports, assignments, and the like, may be provided as journal fields.

For example, a teacher may provide a JournalCard Associate Member ID, and a student may provide a journalcard Subscriber ID. Grading can then be associated with the student's JournalCard subscriber ID number. A parent of a student has the ability to associate the student's JournalCard subscriber ID with an ID of the parent through a subaccount under the parent's “JournalCard” account. Individual grades, progress reports, attendance, and personal notes can be entered under the student's individual “JournalCard” account number, the parent having access to the information via a secure server. Notifications can be established to alert the parent that grades, progress reports and test scores are available. Further alerting and notification may be set-up by the parent to track a specific event, such as a low test score. In addition to keeping track of individual student performance, teachers and school administrators may use JournalCard processing as a tool to inform parents of school events, assemblies, sign-ups, student attendance records, fund raisers, disciplinary problems, and the like.

A teacher can create and post student grades, test scores, progress reports, assignments, and the like via a journalcard transaction.

For example, teachers have the ability to create assignment lists and set them up as JournalCard Schedules with reminders. The assignment list would only need to be created once. Subsequently, the teacher can post a JournalCard transaction to all of the students at once.

According to the transaction processing method, the transaction processor has the capability to associate different types of transactions with the “JournalCard” subscriber 165 for whom the event records were created. In some cases, this is provided as part of the transaction. The “JournalCard” subscriber ID may be provided from data encoded in the “JournalCard” or, alternatively, from the manual entry of the subscriber's ID number. Moreover, an Associate Member may already have the subscriber's number on file.

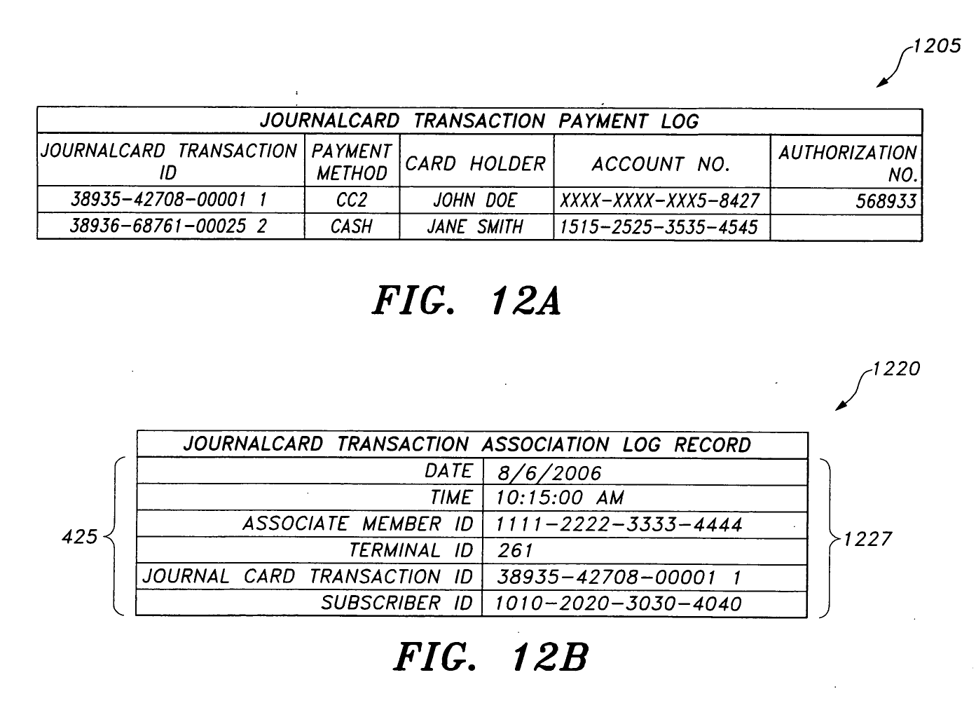

In some cases a comparison of subscriber data fields on file is used to locate and associate the JournalCard subscriber 165 with the transaction. If the number is not provided, the transaction processor 129 then automatically searches the “JournalCard” subscriber database 140 for the transaction Card Holder Name and Account number until it finds a match. The subscriber ID for the matching data is then added to the association log file 1220. FIG. 12A depicts the fields used in payment log 1205 to compare a transaction for purposes of determining the association of the subscriber 165. When a “JournalCard user 165 subscribes, in addition to providing name and contact information, account numbers for existing credit/debit/ATM card, and the like must also be provided. In the event of a CASH, CHECK or similar type transaction where an account number does not associate the client to a transaction, the client can swipe his/her physical “JournalCard” in the same way a credit card is swiped in order to provide the account number that associates the client to the transaction. In the event of a Schedule or similar type transaction where an account number does not associate the client to a transaction, the client can swipe his/her physical “JournalCard” in the same way a credit card is swiped in order to provide the account number that associates the client to the transaction. In the event the “JournalCard Member does not have an operating swipe terminal, the member may manually enter the subscriber's ID number. In the event the transaction is being performed online or remotely, the subscriber ID number may be entered manually. As shown in FIG. 12B, an individual association record 1220 having field descriptors 425 may be populated with data in entry fields 1227 after the subscriber 165 has been associated.

According to the transaction processing method, records in the event database 159 can be encrypted and transmitted to a secure server 129 using global electronic communications, e.g., the Internet, wired/wireless communication methods, and the like. The secure server 129 archives the events in a sequential database 130 by date and time of event, and in a relational database 135 based on event type, category, subcategory or group.

The user 165 can access and process the archived data to provide “journal” activity reports of past events and, when applicable, an expense categorization of the events. Additionally, the user 165 may setup alarms and reminders for upcoming events. The transaction processing center 120 provides the user 165 with the capability to logon to the user's account and create alarm event and notification parameters associated with the user's transactions. Once the alarm event is created, the transaction processing center 120 can monitor transaction log files of the subscriber 165 and compare those files to the alarm event parameters for the subscriber 165. If and when alarm event parameters are met, the transaction processing center 120 can notify the user 165 based on notification parameters setup by the user 165. Alarms may be financial, e.g., a credit card can be monitored, and an alert can be routed to the subscriber if the account charges exceed a predetermined amount in a predetermined time period.

An alarm may be an appointment, e.g., a subscriber's upcoming appointment log can be monitored and the subscriber can be alerted at a predetermined reminder time.

An alarm may be a student's attendance record, e.g., the student's attendance at school can be monitored, and a parent or guardian can receive the alert message. Additionally, an alarm may be related to a student's grade or progress report, e.g., if the student's grade or progress report score drops below a predetermined level, an alert can be generated and directed to a parent or guardian subscriber.

An alarm can be a vehicle maintenance alarm, e.g., the odometer reading of a vehicle can be monitored through a car's black box or other system providing such information, and a notification alarm can be sent to the subscriber once a predetermined odometer reading has been reached.

Alarm notification types are user selectable and may comprise: a text message to a cell phone, a pager, or a PDA; a voice message to a cell phone or landline phone; an e-mail message; an instant message; or combinations of the aforementioned messaging types, and the like.

During alarm event parameters setup, the transaction processing center 120 makes a plurality of common notification messages available for selection by the subscriber 165. Additionally, the subscriber 165 may customize his/her own message. A text message can be sent exactly as input by the subscriber 165. A text-to-speech feature is provided to convert text to voice mail when voice mail notification is selected by the subscriber 165. The subscriber 165 may select whether an alarm is recurring at preset intervals. The subscriber 165 may also select an alarm event to repeat until acknowledged by the subscriber 165.

The user 165 may also download and merge the archived data with software programs, such as Microsoft Money®, Quick Books®, Peachtree®, Franklin Day Planner®, Outlook®, and the like.

Upon remote connection to the event database server, the user 165 may synchronize a journal card memory device with the user's local computer database files. The user 165 can then create an electronic softcopy of the event transactions at the Point of Transaction 100, regardless of connection method 105. Additionally, the user 165 can transmit the electronic copy to a secure server location. Individual components of each transaction can be broken down, categorized and stored in their respective database.

Moreover, as shown in FIGS. 1 and 2, access to the transaction database(s) may be provided over the Internet 155. Using a Web-enabled device, the user 165 can interact with the data for many different purposes, e.g., ordering a printed document 170, such as a sales receipts 101; importing transaction log files into financial software; further categorizing transaction details; performing data searches; creating reports, and the like 160. The data searches may be performed on both financial and non-financial transactions. The search criteria may be by one data field or by a combination of data fields for each type of transaction. Search results can provide subscriber-customized data fields displayed in an online report. The transaction processing center 120 can provide the user 165 with downloadable search reports in a variety of formats, including, but not limited to, a CSV file for use in importing into a financial software package, spreadsheet, document program, and the like.

The user 165 can setup alarm and event notification for financial limits and future events. According to the transaction processing method, log file search engines 150 can be developed that can permit merchants to produce demographic and product purchase profiles based on the transaction log data. Associate members are provided the capability to logon and perform searches of all recorded financial transactions.

The search criteria and results can be limited to specific fields from the financial transaction log file, including SKU Number, Description, Quantity, and Price. Additionally, the search criteria may include a geographic area by zip code and miles surrounding, including demographic profile information, such as median age of subscribers who purchased a specific item. Search results are provided in an online report. The transaction processing center 120 provides associate members with the capability to download search reports in a format, e.g., a CSV file, for use in importing into a spreadsheet or document program. Search criteria and/or results are filtered to exclude any fields that identify the associate member or subscriber of any given transaction.

Search engines provided for associate members can access several product searches or reports, including individual product sales reports, products purchased by certain age groups, and demographical profile information. For product sales reports, associate members can enter a specific item that was purchased in a specific date range, thus allowing the associate member to target market specific items based on geographical market or customer profile.

It is to be understood that the present invention is not limited to the embodiment described above, but encompasses any and all embodiments within the scope of the following claims.

I claim:

1. A computer-implemented transaction processing method, comprising the steps of:
logging events relating to a consumer from at least one point of transaction to form event logs, the event logging being performed at a central transaction processing center;
storing a journal of the events on a server; and
making the event logs available for search, retrieval, display, and documentation by the consumer;
wherein the events that may be logged include: receipts generated by a plurality of merchants doing business with the consumer; cash transactions generated at a plurality of cash transaction venues visited by the consumer; credit transactions generated by a plurality of creditors of the consumer; and non-financial events associated with the consumer, the events being reported from the at least one point of transaction.

2. The computer-implemented transaction processing method according to claim 1, further comprising the steps of:
recording a future action item at the transaction processing center; and
alerting the consumer to perform the action item in a timely manner.

3. The computer-implemented transaction processing method according to claim 1, wherein the step of logging events further comprises the steps of:
logging a work-related activity;
logging a progress report thereof; and
logging an attendance report associated with the work-related activity.

4. The computer-implemented transaction processing method according to claim 1, further comprising the steps of:
providing an account number to the consumer for uniquely associating the consumer with the events and event logs; and
providing portable storage media uniquely identified by the account number to the consumer for use in initiating and accessing the events and the event logs.

5. The computer-implemented transaction processing method according to claim 1, further comprising the steps of:
certifying associate members to process the transactions; and
automatically recording the transaction at the transaction processing center whenever an associate member is involved in the transaction.

6. The computer-implemented transaction processing method according to claim 5, wherein the step of recording the transaction further comprises recording a transaction date, time, and associate member identifier into a record of the logged event.

7. The computer-implemented transaction processing method according to claim 1, further comprising the steps of:
categorizing the events into a plurality of transaction types; and
compiling and logging the events into a database.

8. The computer-implemented transaction processing method according to claim 1, further comprising the step of compiling and logging every line item associated with each of the events at the transaction processing center.

9. The computer-implemented transaction processing method according to claim 1, wherein the step of logging events includes logging scheduling transaction type events.

10. The computer-implemented transaction processing method according to claim 1, wherein said step of logging events comprises logging travel events in order to maintain a trip journal at the transaction processing center.

11. The computer-implemented transaction processing method according to claim 10, the step of logging travel events further comprises logging odometer mileage, runtime hours, and waypoints.

12. The computer-implemented transaction processing method according to claim 10, wherein said step of logging events further comprises logging events when a vehicle engine is started and stopped.

13. The computer-implemented transaction processing method according to claim 1, further comprising the steps of:
recording a future action item at the transaction processing center;
selecting an alert notification method and message; and
alerting the consumer to perform the action item in a timely manner according to the selected alert notification and message.

14. The computer-implemented transaction processing method according to claim 1, wherein the step of making the event logs available for retrieval by the consumer further comprises downloading and merging the event logs with third party accounting and planning software programs.

15. The computer-implemented transaction processing method according to claim 1, further comprising the steps of:
synchronizing the event logs with local database files maintained by the consumer; and
transmitting the synchronized event logs and database files to a secure server location.

16. The computer-implemented transaction processing method according to claim 1, further comprising the steps of:
searching all event logs at the transaction processing center for demographic and product purchase profile information; and
permitting authorized merchants access to the demographic and product purchase information.

17. A transaction processing method, comprising the steps of:
publishing a web site accessible to merchants and consumers;
maintaining at least one back-end database and database server in communication with the web site;
establishing unique accounts through the web site for individual subscribers, including establishing maintaining a table of identifying information relating to each of the individual subscribers' unique account;
logging financial transaction events for each of the individual subscribers onto the at least one database in records associated with the individual subscribers' unique account in response to financial transaction data submitted to the web site by merchants from a point of transaction at a time when the financial transaction takes place;
forming a journal of financial transaction events for each of the individual subscribers from the events recorded in the at least one database;
logging personal transaction events for each of the individual subscribers onto the at least one database in records associated with the individual subscribers' unique account;
forming a journal of personal transaction events for each of the individual subscribers from the events recorded in the at least one database; and
searching, retrieving, displaying in a web page, and downloading data from the financial and personal journals through the web site upon request of the individual subscriber for data associated with the individual subscriber's account.

18. The transaction processing method according to claim 17, further comprising the step of sending an alert notification to the individual subscriber concerning an upcoming event logged into the database at a time and according to a method selected by the individual subscriber.

19. The transaction processing method according to claim 17, further comprising the step of issuing an identification card to each of the individual subscribers having a unique account identifier recorded thereon in a form readable by an electronic reader for logging cash transaction events.

20. The transaction processing method according to claim 17, further comprising the step of downloading data from the individual's financial journal in a format permitting integration with files maintained by the individual subscriber's financial and accounting software.
